(19) United States
(12) Patent Application Publication
(10) Pub. No.: US 2011/0296702 A1
(43) Pub. Date: Dec. 8, 2011

(54) Laundry Machine with a Heat Pump System and Motor Control Therefor

(75) Inventors: Sergio PILLOT, Pasiano di Pordenone (IT); Stefano ZANDONA, Porcia (IT)

(73) Assignee: ELECTROLUX HOME PRODUCTS CORPORATION N.V., Brussels (BE)

(21) Appl. No.: 13/152,010

(22) Filed: Jun. 2, 2011

(30) Foreign Application Priority Data
Jun. 4, 2010 (EP) 10164982.0

(51) Int. Cl. H02P 25/04; F26B 21/06

(52) U.S. Cl. 34/72; 318/794

(57) ABSTRACT

An electric motor (10) drives a compressor (40) of a heat pump system in a laundry machine, e.g., a tumble dryer. The electric motor (10) is an asynchronous motor. The electric motor (10) includes a main coil (12) and an auxiliary coil (14). A control unit (22, 24, 26) is dedicated to the electric motor (10). The control unit includes capacitance circuitry including at least one capacitor (22, 24). The main coil (12) is parallel-connected to a series including the auxiliary coil (14) and the at least one capacitor (22, 24). The main coil (12) is connected or connectable to a power source (34). The capacity of the capacitance circuitry is variable depending directly or indirectly on parameters including, e.g., the actual torque of the electric motor (10). Further, the present invention relates to a method for operating the laundry machine with the heat pump system (10).

### CROSS-REFERENCE TO RELATED APPLICATION

This application claims priority to European Application No. 10164982.0 filed Jun. 4, 2010.

### BACKGROUND OF THE INVENTION

The present invention relates to a laundry machine with at least one heat pump system comprising at least one compressor and at least one electric motor for driving the compressor. Particularly the laundry machine is a tumble dryer or a washing machine with drying functionality, however the present invention is also applicable to a washing machine with a heat pump system for heating up the washing water.

Further, the present invention related to a method for operating the laundry machine with the heat pump system.

It is efficient to save energy in a laundry machine by the use of the heat pump technology. For example, a tumble dryer with the heat pump system may comprise a closed air stream circuit and a closed refrigerant circuit. The air stream circuit and the refrigerant circuit are coupled by at least two heat exchangers.

In the refrigerant circuit the refrigerant is compressed and heated by a compressor. The compressor is driven by an electric motor, e.g. by an asynchronous motor. Usually the electric motor of the compressor has no complex control device. The control unit includes only a few electric and/or electronic elements, wherein the electric motor is optimized only for the normal operation.

However, during the heat-up phase of the compressor the electric motor and its control unit are not optimized. In the heat-up phase the compressor has to move less mass of refrigerant than during the normal operation. Thus, the efficiency, i.e. the relationship between the absorbed power and the supplied power is relative low during said heat-up phase.

DE 10 2005 041 145 A1 discloses a tumble dryer with a heat pump system. The heat pump system comprises a compressor with variable power. The power of the electric motor driving the compressor is controlled by a control device. Such a control device is usually very complex and comprises a plurality of electronic elements, in particular active electronic elements.

It is an object of the present invention to provide a laundry machine with at least one heat pump system comprising at least one compressor and at least an electric motor for driving the compressor, which can be optimized for several load ranges of said compressor.

The above object of the present invention may be achieved by a laundry machine with an electric motor for driving a compressor, as claimed.

According to an aspect of the present invention:
the electric motor is an asynchronous motor,
the electric motor includes a main coil and an auxiliary coil,
a control unit is dedicated to the electric motor,
the control unit includes at least one capacitor,
the main coil is parallel-connected to a series including the auxiliary coil and the at least one capacitor,
the main coil is connected or connectable to a power source, and
the capacity of the at least one capacitor is variable depending directly or indirectly on the actual torque of the electric motor.

A main idea of the present invention is the variable capacity between the main coil and the auxiliary coil. Said capacity causes a phase shift between the main coil and the auxiliary coil. The phase shift affects the behaviour of the efficiency of the electric motor in dependence on its torque. A lower capacity of the capacitor allows a maximum efficiency to be obtained at a lower torque of the electric motor. In a similar way, a higher capacity of the capacitor allows a maximum efficiency to be obtained at a higher torque of the electric motor. Thus, during the heat-up phase (an initial operation phase of the compressor) the capacity is switched or controlled at the lower value. During the normal operation (steady state operation of the compressor or subsequent operation phase of the compressor) the capacity is switched or controlled at the higher value. This increases the overall efficiency and reduces the energy consumption.

According to a preferred embodiment of the present invention the control unit includes a first capacitor permanently series-connected to the auxiliary coil.

Further, the control unit may include at least one second capacitor series-connected to a switch, wherein said series is parallel-connected to the first capacitor. The use of capacitors allows a control unit with low complexity.

Additionally, the control unit may include at least one further second capacitor series-connected to a further switch, wherein said series is parallel-connected to the first capacitor. This allows further options for setting the maximum of efficiency in dependence of the torque.

Alternatively or additionally, at least one of the one or more capacitors comprises a variable capacitor. The adjustable capacitor allows a continuous setting to obtain maximum efficiency in dependence of the torque.

The states of the switch and/or the variable capacity, respectively, may depend on the temperature of the fluid moved by the compressor.

The states of the switch and/or the variable capacity, respectively, may depend on the pressure of the fluid moved by the compressor.

Preferably the temperature and/or pressure is/are detected at the compressor and/or condenser outlet.

The states of the switch and/or the variable capacity, respectively, may depend on the torque transmitted from the electric motor to the compressor.

The present invention relates further to a tumble dryer with a heat pump system comprising at least one compressor, wherein the compressor is driven by an electric motor as described above.

At least one compressor may be provided for moving a refrigerant in a refrigerant circuit of the heat pump system.

The states of the switch and/or the variable capacity, respectively, may depend on the temperature and/or the pressure of the refrigerant.

The states of the switch and/or the variable capacity, respectively, may depend on the humidity and/or temperature of an air stream of the heat pump system.

The present invention relates also to a method for operating a laundry machine with at least one heat pump system comprising at least one compressor and at least an electric motor for driving the compressor, wherein the electric motor is an asynchronous motor including a main coil, an auxiliary coil and at least one capacitor between the main coil and the auxiliary coil. The method includes the step of switching and/or controlling the capacity of the at least one capacitor at a lower value during an initial operation phase of the compressor, and switching and/or controlling the capacity of the at least one capacitor at a higher value during a subsequent operation phase of the compressor.

Preferably, switching and/or controlling the capacity of the at least one capacitor depends on at least one of the following:
the temperature and/or on the pressure of the fluid moved by the compressor,
the torque transmitted from the electric motor (10) to the compressor,
the power absorbed by the compressor, and
the humidity and/or temperature in an air stream of the heat pump system.

The present invention relates also to a method for operating a laundry machine with at least one heat pump system comprising at least one compressor and at least an electric motor for driving the compressor, wherein the electric motor is an asynchronous motor including a main coil, an auxiliary coil and at least one capacitor between the main coil and the auxiliary coil. The method includes the step of varying the capacity (capacitance) of the at least one capacitor depending directly or indirectly on the actual torque of the electric motor so that a lower capacity of the capacitor causes that the maximum efficiency of the compressor to be obtained at a lower torque of the electric motor and a higher capacity of the capacitor causes maximum efficiency of the compressor to be obtained at a higher torque of the electric motor.

Additional novel and inventive features of the present invention are set forth in the appended claims.

### BRIEF DESCRIPTION OF THE DRAWINGS

The invention will be described in further detail with reference to the drawings, in which:

FIG. 1 illustrates a schematic circuit diagram of a control unit for an electric motor according to a preferred embodiment of the present invention,

FIG. 2 illustrates two graphs representing the efficiency of the electric motor as function of a torque according to the preferred embodiment of the present invention,

FIG. 3 illustrates a schematic circuit diagram of the control unit for the electric motor according to an alternative embodiment of the present invention, and

FIG. 4 illustrates a schematic diagram of an exemplary laundry machine (specifically a laundry dryer) with a heat pump system to which the invention may be applied.

### DETAILED DESCRIPTION OF EXAMPLE EMBODIMENTS

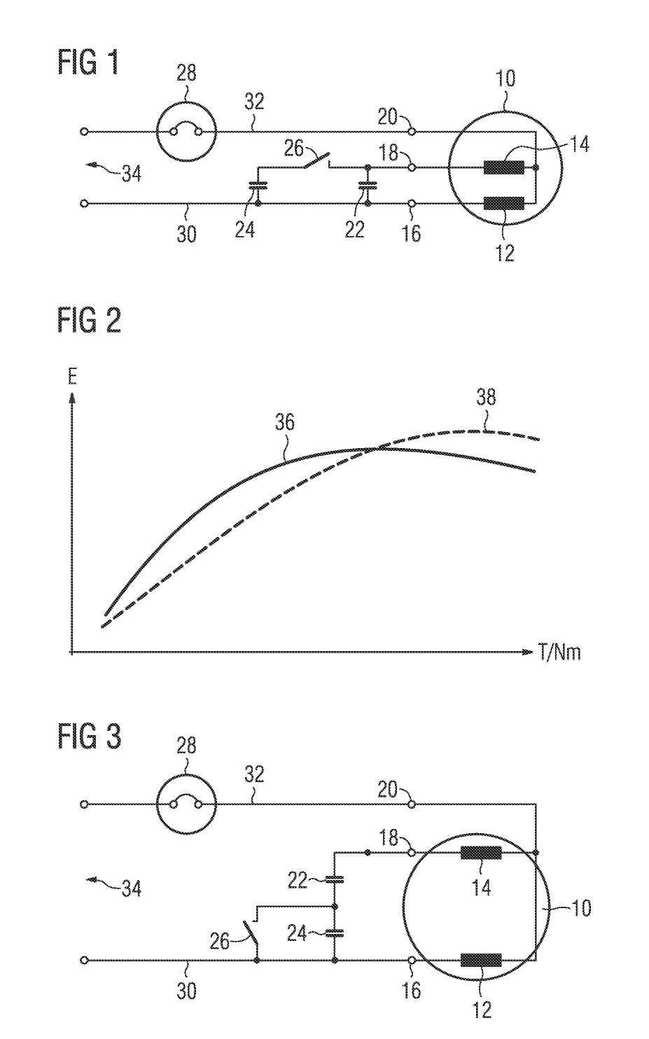

FIG. 1 illustrates a schematic circuit diagram of a control unit for an electric motor 10 according to a preferred embodiment of the present invention. The electric motor 10 is an asynchronous motor. The electric motor 10 includes a main coil 12 and an auxiliary coil 14.

Further, the electric motor 10 comprises a first terminal 16, a second terminal 18 and a third terminal 20. The first terminal 16 is connected to a first end of the main coil 12. The second terminal 18 is connected to a first end of the auxiliary coil 14. The third terminal 20 is connected to second ends of the main coil 12 and auxiliary coil 14. Thus, the second ends of the main coil 12 and auxiliary coil 14 are interconnected.

The control unit for the electric motor 10 includes a first capacitor 22, a second capacitor 24, a switch 26 and, preferably, an overload protector 28. Further, the control unit for the electric motor 10 comprises a first power supply line 30 and a second power supply line 32. The first power supply line 30 and the second power supply line 32 are connected or connectable to a power source 34.

The first power supply line 30 is connected to a first contact of the first capacitor 22 and to a first contact of the second capacitor 24. The switch 26 is interconnected between a second contact of the first capacitor 22 and a second contact of the second capacitor 24. Thus, the first capacitor 22 and the second capacitor 24 are parallel connected, when the switch 26 is on. Further, the second contact of the first capacitor 22 is connected to the second terminal 18 of the electric motor 10.

The second power supply line 32 is connected to a first contact of the overload protector 28. A second contact of the overload protector 28 is connected to the third terminal 20 of the electric motor 10.

If the switch 26 is off, then the auxiliary coil 14 is connected in series to the first capacitor 22. If the switch 26 is on, then the auxiliary coil 14 is connected in series to the parallel capacitors 22 and 24. The on-state of the switch 26 cause a higher capacity between the first power supply line 30 and the auxiliary coil 14 than the off-state of the switch 26.

The capacities of the capacitance circuitry provided between the first power supply line 30 and the auxiliary coil 14 cause a phase shift between the main coil 12 and the auxiliary coil 14. The phase shift impacts the behaviour of the efficiency of the electric motor 10.

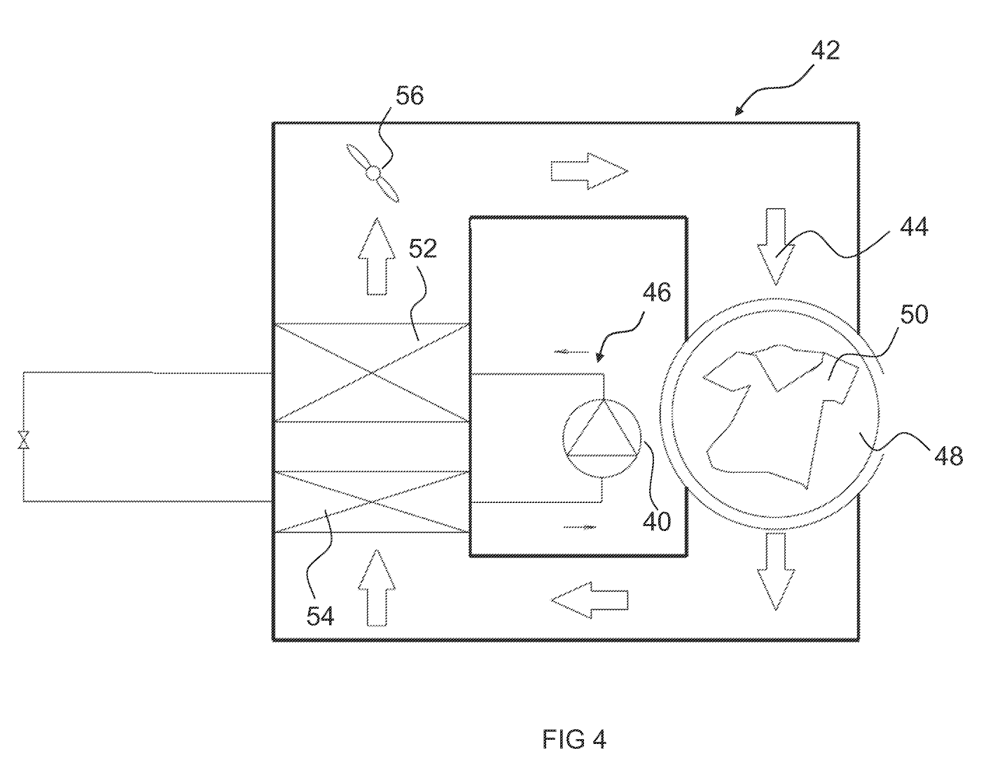

With reference to FIG. 4, the electric motor 10 is provided for driving a compressor 40 of a heat pump system in a tumble dryer 42. The tumble dryer 42 with the heat pump system comprises an air stream circuit 44, preferably a closed air stream circuit, a refrigerant circuit 46 and a drum 48.

The drum 48 is an integrated part of the air stream circuit 44 and is provided for receiving laundry 50. The compressor 40 is an integrated part of the refrigerant circuit 46. The air stream circuit 44 and the refrigerant circuit 46 are thermally coupled by a first heat exchanger 52 and a second heat exchanger 54. The first heat exchanger 52 works as a condenser (with respect to the refrigerant). The second heat 54 exchanger works as an evaporator (with respect to the refrigerant).

In the air stream circuit 44, an air stream is generated by at least a fan 56. A refrigerant flows in the refrigerant circuit 46. The refrigerant is compressed and heated by the compressor. The heated refrigerant reaches the condenser 52. In the condenser the air stream is heated and the refrigerant is cooled down. Then the heated air steam enters the drum 48 for removing moisture from the laundry 50 contained inside the rotatable drum 48. Between the condenser 52 and the evaporator 54 the refrigerant is expanded and additionally cooled down by suitable means. After having passed through the laundry and come out from the drum 48, in the evaporator 54 the air stream is cooled down and the refrigerant is warmed up. Then, the refrigerant is compressed and heated by the compressor 40 again. The compressor 40 is driven by the electric motor 10 (FIGS. 1 and 3). The air stream is sent back into the drum 48 after having passed through the condenser 52 to be duly heated.

FIG. 2 illustrates two graphs 36 and 38 representing the efficiency E of the electric motor 10 as function of a torque of said electric motor 10 according to a preferred embodiment of the present invention. The efficiency E represents the ratio of supplied power to absorbed power.

The graph 36 represents the efficiency of the electric motor 10, if the switch 26 is off. In this case only the first capacitor 22 is connected in series with the auxiliary coil 14. Said series is parallel-connected to the main coil 12. In this state the maximum efficiency of the electric motor 10 is in the medium range of the torque spectrum.

The graph 38 represents the efficiency of the electric motor 10, if the switch 26 is on. In this case the first capacitor 22 and the second capacitor 24 are parallel-connected. Said parallel capacitors 22 and 24 are connected in series with the auxiliary coil 14. Said series is parallel-connected to the main coil 12 again. In this state the maximum efficiency of the electric motor 10 is in the upper range of the torque spectrum.

The switch 26 is controlled by one or more physical parameters of the electric motor 10, the compressor and/or the heat pump system. For example, the switch 26 is controlled on the basis of the temperatures and/or pressures in the heat pump system. Alternatively or additionally, the switch 26 may be controlled on the basis of the energy consumption of the compressor. Further, the pressure and/or the temperature of the refrigerant in the heat pump system may control the switch 26.

This simple circuit containing the first capacitor 22, the second capacitor 24 and the switch 26 allows an optimizing of the efficiency of the electric motor 10 by low complexity. In particular, the energy absorption of the compressor is reduced during the heat-up phase. Further, the overall energy consumption is also reduced.

The state of the switch 26 may depend on the braking torque of the electric motor 10. The braking torque can be determined indirectly by detecting the power absorbed by the compressor via current absorbed feedback and/or by measuring the refrigerant temperature at the condenser/compressor outlet in order to determine the pressure of the heat pump circuit. A high pressure value means a high working stress of the electric motor 10. For the indirect determination of the braking torque the characteristic curve of the electric motor 10 has to be known.

FIG. 3 illustrates a schematic circuit diagram of the control unit for the electric motor 10 according to an alternative embodiment of the present invention.

The electric motor 10 includes the main coil 12 and the auxiliary coil 14 as well as the first terminal 16, the second terminal 18 and the third terminal 20. The first terminal 16 is connected to the first end of the main coil 12. The second terminal 18 is connected to the first end of the auxiliary coil 14. The third terminal 20 is connected to second ends of the main coil 12 and auxiliary coil 14. The control unit for the electric motor 10 includes, preferably, the overload protector 28 interconnected between the second power supply line 32 of the power source 34 and the third terminal 20. Thus, the main coil 12, the auxiliary coil 14 and the overload protector 28 are connected to the terminals 16, 18 and 20 in the same way as in FIG. 1.

The control unit of the alternative embodiment differs from the embodiment in FIG. 1 in the arrangement of capacitance circuitry, i.e., first capacitor 22, the second capacitor 24 and the switch 26. The first capacitor 22 and the second capacitor 24 are connected in series between the first terminal 16 and the second terminal 18. The switch 26 is connected in parallel to the second capacitor 24. When the switch 26 is open, then the series of the first capacitor 22 and the second capacitor 24 are connected between the first terminal 16 and the second terminal 18. When the switch 26 is closed, then only the first capacitor 22 is connected between the first terminal 16 and the second terminal 18.

When the switch 26 is open (off), then the electric motor 10 works according to the first graph 36 in FIG. 2, since the resulting capacity is determined by the series of the both capacitors 22 and 24. When the switch 26 is closed (on), then the electric motor 10 works according to the second graph 38 in FIG. 2, since the second capacitor 24 is bypassed and the resulting capacity increases. The values of the first capacitor 22 and the second capacitor 24 may be selected in such a way that the behaviour of the electric motor 10 corresponds with FIG. 2.

Clearly the present invention can also be applied to a washing machine having a heat pump system to heat up the washing water.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 electric motor
12 main coil
14 auxiliary coil
16 first terminal
18 second terminal
20 third terminal
22 first capacitor
24 second capacitor
26 switch
28 overload protector
30 first power supply line
32 second power supply line
34 power source
36 first graph
38 second graph
40 compressor
42 tumble dryer
44 air stream circuit
46 refrigerant circuit
48 drum
50 laundry
52 first heat exchanger
54 second heat exchanger
E efficiency

1. A laundry machine with at least one heat pump system comprising at least one compressor and at least an electric motor for driving the compressor, wherein:
the electric motor is an asynchronous motor,
the electric motor includes a main coil and an auxiliary coil,
a control unit controls operation of the electric motor,
the control unit includes capacitance circuitry including at least one capacitor,
the main coil is parallel-connected to a series including the auxiliary coil and the capacitance circuitry,
the main coil is connected or connectable to a power source, and
the capacitance of the capacitance circuitry is variable depending directly or indirectly on the torque of the electric motor.

2. The laundry machine according to claim 1, wherein the capacitance circuitry includes a first capacitor permanently series-connected to the auxiliary coil.

3. The laundry machine according to claim 2, wherein the capacitance circuitry includes at least one second capacitor series-connected to a switch, wherein said series is parallel-connected to the first capacitor.

4. The laundry machine according to claim 3, wherein the capacitance circuitry includes at least one further second capacitor series-connected to a further switch, wherein said series is parallel-connected to the first capacitor.

5. The laundry machine according to claim 1, wherein the capacitance circuitry includes a first capacitor and second capacitor series-connected, and a switch parallel-connected to the second capacitor.

6. The laundry machine according claim 1, wherein the capacitance circuitry comprises a variable capacity capacitor.

7. The laundry machine according to claim 1, wherein a state of the capacitance circuitry depends on the temperature and/or on the pressure of the fluid moved by the compressor.

8. The laundry machine according to claim 1, wherein a state of the capacitance circuitry depends on the torque transmitted from the electric motor to the compressor.

9. The laundry machine according to claim 1, wherein a state of the capacitance circuitry depends on the power absorbed by the compressor.

10. The laundry machine according to claim 1, wherein a state of the capacitance circuitry depends on the humidity and/or temperature in an air stream of the heat pump system.

11. The laundry machine according to claim 1, wherein the heat pump system comprises an air stream circuit, a refrigerant circuit and a drum.

12. The laundry machine according to claim 11, wherein the air stream circuit is a closed air stream circuit.

13. The laundry machine according to claim 11, wherein the air stream circuit and the refrigerant circuit are thermally coupled by a first heat exchanger and a second heat exchanger, the first heat exchanger working as a condenser and the second heat exchanger working as an evaporator.

14. The laundry machine according to claim 13, wherein in the condenser the air stream is heated and the refrigerant is cooled down, and in the evaporator the air stream is cooled down and the refrigerant is warmed up.

15. A method for operating a laundry machine with at least one heat pump system comprising at least one compressor and at least an electric motor for driving the compressor, wherein the electric motor is an asynchronous motor including a main coil and an auxiliary coil, and capacitance circuitry is provided comprising at least one capacitor between the main coil and the auxiliary coil, the method comprising:
controlling the state of the capacitance circuitry to have a lower capacitance value during an initial operation phase of the compressor, and
controlling the state of the capacitance circuitry to have a higher value during a subsequent operation phase of the compressor.

16. The method according to claim 15, wherein the control of the state of the capacitance circuitry depends at least on one of the following:
the temperature and/or on the pressure of the fluid moved by the compressor,
the torque transmitted from the electric motor to the compressor,
the power absorbed by the compressor, and
the humidity and/or temperature in an air stream of the heat pump system.

17. The method according to claim 15, wherein the step of controlling the state of the capacitance circuitry comprises switching a capacitor in or out of the circuit.

18. The method according to claim 15, wherein the step of controlling the state of the capacitance circuitry comprises changing the capacitance of a variable capacitor of the circuitry.
